(19) United States
(12) Patent Application Publication
(10) Pub. No.: US 2007/0050218 A1
(43) Pub. Date: Mar. 1, 2007

(54) Engraftment of stem cell technology to life insurance policies and methods of reducing payouts on same

(76) Inventors: Frederick J. Fitzsimmons, Wilmette, IL (US); Daniel D. Richard, Boynton Beach, FL (US)

Correspondence Address: COLEMAN SUDOL SAPONE, P.C., 714 COLORADO AVENUE, BRIDGE PORT, CT, 06605-1601, US

(21) Appl. No.: 11/506,952

(22) Filed: Aug. 18, 2006

Related U.S. Application Data
(60) Provisional application No. 60/710,376, filed on Aug. 23, 2005.

(51) Int. Cl. G06Q 40/00

(52) U.S. Cl. 705/4

(57) ABSTRACT

The present invention relates to including the invention in Key-Person, Term Life, or Critical Illiness Insurance policies to provide potential life-saving and health enhancements in addition to the death benefits covered under existing policies. The collection, processing and cryo-preservation of adult stem cells from any adult source, taken from peripheral blood, umbilical cord blood, bone marrow, adipose, heart, muscle, skin, nasal, liver, kidney, pancreas, testes, or other adult sources can also be used as a rider to insurance policies or to the in-benefits for the sale of products or services. The resulting method will substantially reduce the costs and extend premium payments for insurance companies as payouts for death benefits on Key-Person, Term Insurance, or Critical Illiness Insurance policies will be markedly reduced as therapies extend the life of the insured.

### RELATED APPLICATIONS

This application claims the benefit of priority of U.S. Provisional application Ser. No. 60/710,376, filed Aug. 23, 2005, which is incorporated herein by reference in its entirety.

### FIELD OF INVENTION

The present invention relates to including in Key-Person, Term Life or Critical Illness Insurance policies to provide potential life-saving and health enhancements in addition to the death benefits covered under existing policies. The collection, processing and cryo-preservation of adult stem cells taken from peripheral blood or any other adult source can be used as a rider to insurance policies or to the in-benefits for the sale of products or services. The resulting method will substantially reduce the costs for insurance companies as payouts for death benefits on key-person, term life or critical illness policies will be markedly reduced as therapies extend the life of the insured.

The present invention also relates to insurance policies with high premiums which have a built-in stem cell storage clause included within the policy. The clause can specify storage of stem cells from the insured for any period of time, however, storage of stems cells

### BACKGROUND OF INVENTION

Key-Person Insurance policies are sold to corporations, businesses and individual clients for the purposes of obtaining the services of a qualified replacement executive. In many instances, the death benefits are used to buy out heirs or others who have positions of equity in the company. Depending on the need for corporate or individuals, the face value of these policies can run into many millions of dollars.

Term life insurance policies can costs millions of dollars in benefits, depending upon the policy. Most term life insurance policies are in effect for 10 or 20 years, although policies of shorter or longer duration are not uncommon.

The commissions paid to the selling agents can run into hundreds of thousands of dollars for extremely large Key-Person Life Insurance policies. Currently, all these policies pay upon the death of the insured. Many companies now include critical illness coverage where they will pay for many costly hospital procedures such as bone marrow or stem cell transplants and organ replacements, among other serious diseases. Obviously, any rider that can extend life, enhance health, or mitigate protracted hospital stays would be very important to the insurer, because such an approach may markedly reduce the payout on the policy.

### Brief Description of the Invention

It is known that stem cells can be expanded, programmed or reprogrammed into other types of cells to treat diseases which may currently be incurable. The present method is directed to the inclusion of a rider or other clause in an insurance policy, and is used to enhance the profitability of life or other insurance policies of limited term (i.e. Key-person, term life including critical illness insurance policies) where the extension of life or the reduction in costs associated with the treatment of an insured is deemed desirable.

The insurance company actuaries could easily determine the amount of the revenue the insurance company could derive for each year of extended life. Obviously, the premiums would continue to be paid if death benefits were delayed. With this unique business method approach, the insurance company and possibly the agent (subject to compliance regulations), could include the harvesting, processing and long-term stem cell cryo-preservation as a part of the policy or a rider to the policy.

The approach can apply to any stem cell which may be used to extend the life of the insured, but will advantageously apply commonly to adult stem cells from any adult source and in particular, autologous (obtained from the insured) stem cells, which may be obtained from the insured by any method well known in the art, purified using standard cell purification techniques including flow cytometry, cryopreserved, expanded, programmed and/or reprogrammed (the last three steps being performed in any order), stored, restored and used in an autologous treatment method. The stem cells may be used to treat neurodegenerative diseases, numerous cancers, including hematopoietic cancers, heart disorders, anemia, genetic defects and to regenerate and replace depleted blood cells, among other diseases and disorders.

The present invention provides a method for facilitating the preservation of life-extending biological materials such as stem cells from the insured. The well-established methods and apparatus of the insurance industry provide a vehicle for financially supporting and thereby promoting and advancing the preservation and storage process. Moreover, the benefit could come at no or low cost to the insurance industry-indeed, the approach is cash-flow positive as it will extend the life of the insured, extend premium payments to the insurance carrier and reduce the payout of the insurance policy to the beneficiary. Thus, in the present method an insurance company is provided with a reduction in cash benefits to be paid to a beneficiary, a more favorable cash flow and a favorable marketing concept to promote the sale of insurance policies. Other possible benefits to the insurance company are described hereinafter.

The present invention is directed to a key-person, term life or critical illness insurance policy having an ancillary service which exists to extend the life of the insured. The invention contemplates offering alone or as a service ancillary to the policy, the long-term storage and preservation of cellular or other biological material (whether tissue based, cellular or molecular, including DNA and polypeptide) of a policy holder, a secondary insured or a third party beneficiary for a fixed annual fee. Under the present method, the preparation of the biological material for storage is performed under standard procedures (generally, cryopreservation) well known in the art and is paid for by the insurance company, incorporated into the policy premium(s), or offered as a rider to the base policy. The actual cost of the preparation in the present method is often substantially less than the average savings to the insurance company in the form of reduced payouts to beneficiaries of the insurance policy and increased premium payments to the insurance carrier derived from the policy holder.

After collection, testing and processing of biological material, the cost of these initial preservation steps being preferably covered by the insurance company (either through general cost savings or from the cost of the base policy, or insurance policy rider), the insurance company or policy holder will pay a periodic, e.g., annual, fee to continue the storage and preservation of the biological material. The periodic fee may be paid for directly by the insurance company or may be drawn from the base insurance policy premium, from an insurance policy rider or from the cash value of a policy or may be paid directly to the preservation and storage company by the policy holder. The cost of the preservation/storage fee will preferably be a reasonable cost in order to induce the insurance company or policy holder to continue to pay the storage costs. For example, a fee of about $180-275 (typically, about $225) per year for processing and preservation/storage by the third party would provide an acceptable margin for the insurance company, especially given the savings to be realized by employing the present method. The fee may be used by the insurance company to pay for preservation and storage of the biological material by a third party, or alternatively, the insurance company may joint venture or split the fee with the storage provider. In either case, a non-financial services company is paid by the insurance company for the performance of non-financial services—for the substantial benefit of the insurance company.

The value of the present method to the insurance company is much greater than the cost to maintain/preserve the biological material and greater even than the cost of therapy for the insured. The resulting extension of life of the insured substantially reduces the cost of policy payouts and increase policy premium payments to the insurance carrier. The present invention therefore represents a business approach which is heretofore nonexistent in the insurance industry.

Another advantage of the present invention is that biological material, in particular, adult stem cells, are becoming increasingly valuable for medical/treatment purposes. During the period of the insurance policy, the insurance company may maintain and store, through a third party, a sample of stem cells which may prove therapeutically beneficial for the extension of the insured's life. In certain instances, as a condition pertinent to the base policy or policy rider, or alternatively, if no such policy condition exists, then, after the insured dies, an agreement can be made with the individual policy holder's beneficiary(s) (e.g. a company, family member, or other designated beneficiary(s) of an insured) to allow ownership of the biological material to be: 1.) maintained by the beneficiary, with the beneficiary then assuming responsibility for the annual stem cell specimen storage payments, or 2.) the agreement can designate that storage payments will cease to be paid and the stem cell stored specimen can be transferred to a research facility for further medical use and/or research, or 3.) payments to the third party stem cell specimen storage company could be allowed to lapse, with the beneficiary(s) relinquishing all rights to the stored stem cell specimen and ownership of the stored specimen then reverting to the third party storage company to dispose of in any manner it deems appropriate.

The present invention may be used by insurance companies or related companies which provide insurance policies to corporations and other policy holders and is not limited to the type of company or individual providing the policy. For example, the present invention may be used in key-person, term life or critical illness insurance policies by providing for the storage and/or maintenance of biological material (such as DNA, proteins and adult stem cells from any adult source including from a mononuclear fraction of the blood of the insured, which would contain stem cells, marrow cells, etc.) which could be used in case the insured were to contract a debilitating disease. This method would provide coverage ancillary to an insurance policy such that the biological material could be used in the event the insured (e.g. executive or other key person) was to be stricken. This would allow the insurance company to reduce the likelihood of a payout to the beneficiary of the insured inasmuch as the stem cell preservation would likely be used therapeutically to extend the life of the insured, in many cases, beyond the term of the policy. The substantial reduction and/or delay in payout costs by the insurance company would have a beneficial effect on the insurance company cash-flow and profitability, without incurring substantial additional costs. The insurance company could even charge additional fees for the maintenance of the biological material, or alternatively, may provide a basis to reduce the cost of the insurance policy to the company or individual purchasing the policy for key employees.

The present method also derives benefit from the recognition that the science of medicine and biology continues to advance, and the present invention may provide individuals with an opportunity to store biological material for the purpose of allowing future science and developments to find a therapeutic use for that material.

The present invention contemplates that when the term policy expires, the provision of the ancillary services terminate. At the end of the insurance term, if desired, there may a retrieval and delivery of the preserved and stored biological material under the auspices of the ancillary service provider. In this event, the requester is typically responsible for the costs of the retrieval and delivery procedures. The transfer of the preserved materials generally, but not necessarily, terminates the obligation of the insurance company (and the policy holder) to make payments to the ancillary service provider. Alternatively, the former insured policy holder, or the beneficiary(s) of the policy upon the death of the insured may, 1.) Elect to maintain ownership of the stored stem cell specimen by agreeing to continue paying annual stem cell specimen storage costs to the third party storage company, or 2.) Choose to terminate such ownership by deciding to not continue paying annual storage fees to the third party storage company and may elect to donate the stem cell specimen to a research facility for further medical use and/or research, or 3.) Cease annual storage payment with the third party storage company and, in so doing, relinquish all rights to the stored specimen, with ownership of the stored specimen then reverting to the storage company to dispose of in any manner it deems appropriate.

### Definitions

The following terms, in certain instances, shall be used in describing the present invention.

BONE MARROW—The milky-like substance found in the center of bones which produces all of the body's blood cells.

PERIPHERAL BLOOD—Blood circulating through the veins and arteries.

STEM CELL—The vital cell produced in the bone marrow of all vertebrates which is capable of reproducing itself or developing into other types of blood cells and/or other adult stem and tissue cells.

UMBILICAL CORD—The strand of tissue connecting the fetus to the placenta. It contains the blood vessels that supply nutrients to the fetus. During the gestation period nutrients are brought to the baby and waste materials are disposed from the fetus through the umbilical cord blood.

ANCILLARY SERVICES—Services provided by a non-insurance company to an insured person or a third-party beneficiary of an insurance policy to further the interests of the insured in taking out the insurance policy. Typically, the services are to be performed either continuously or periodically during the term of the insurance policy or a portion thereof. Exemplarily, where the insurance policy is Key-person or Term life or Critical Illness insurance, the ancillary services may be the preservation and storage of biological material such as adult stem cells from any adult source, umbilical cord blood, placental blood, DNA, peripheral blood, bone marrow adipose and other tissue sources for possible future use during the term of the policy. Alternatively, the ancillary services may be directed to the performance of preventive health measures, which are not typically covered directly by conventional health insurance.

INITIALIZATION COSTS—Charges incurred to start the providing of ancillary services. Where the ancillary services are the preservation and storage of biological materials, the initialization costs cover the collection of one or more specimens, the testing of the specimens, for instance, for viability and purity, and the processing of the specimens, for instance, by adding a cryopreservative and reducing the temperatures of the specimens pursuant to a known schedule. These initial services are performed in part by third-party service providers including hospitals and testing and stem cell processing, testing cryopreservation and storage laboratories. The initialization costs may also include incidental expenses, for example, bookkeeping and documentation costs incurred in setting up an account. These costs are born by insured/beneficiary of the insurance policy or the costs are incorporated into the cost of the base insurance policy or policy rider, depending on the insurance policy. Preferably the costs are incorporated into the costs of the insurance policy and administered by the insurance company, to make it more likely that payments always will be made.

BIOLOGICAL MATERIALS—Any organic matter useful for medical and diagnostic purposes. Organic matter tends to decompose in naturally occurring processes and thus requires special preservation to insure viability at a later time. Biological materials include adult stem cells from any adult source, umbilical cord blood, placental blood, DNA, peripheral blood, bone marrow, adipose and other tissue sources, but may also include tissue samples and organ parts or wholes of any useful type. Other specific kinds of biological materials which are possibly useful in carrying out the method of the present invention include corneas, vascular tissues, skin, nasal, muscle, kidneys and kidney tissues, liver, pancreas, testes, etc.

PRESERVATION AND/OR STORAGE COMPANY—A corporation whose business includes preserving and storing biological materials.

POLICY HOLDER—A natural or legal person who establishes a contract with an insurance company for a key-person, term life or critical illness policy for receiving financial services in return for one or more monetary payments to the insurance company. The financial services are typically of a contingent nature and are paid out or performed only if an event occurs as provided for in the contract. In the present invention, such an event is typically the death of the insured. The insured is the person insured by the policy, who may or may not be the same person as the policy holder.

BENEFICIARY—A person designated by a holder of an insurance policy as a recipient of benefits under the policy. A beneficiary is typically a person who is not customarily named as a secondary insured on an insurance policy and may even be someone unrelated to the policy holder.

### EXAMPLE

The cost of providing the stem cell collection, processing, testing, cryopreservation service and 10-20 years of cryo-storage could be in the range of $1,800 to $5,500 (i.e. more typically in the range of $2,250 to $4,500 for 10-20 years) proportionately more for longer term storage, including insurance carrier and third party ancillary services stem cell processing, testing, cryopreservation and storage company.

This invention will greatly enhance the sale of key-person, term life and critical illness insurance and other policies. It will now provide the stem cell technology benefits that can help the insured during his or her lifetime in addition to coverage in the event of death.

This will provide the insurance company much “goodwill” and potential sale for the protection of the insured families.

As a matter of implementing the invention, immediately upon the purchase of the policy, the insured would be given a certificate covering the harvesting, processing, and cryo-preserving for 10-20 years (or possibly more). A phlebotomist or perfusionist or any technician licensed to draw blood will be dispatched to the insured's place of business, home, or a qualified lab or repository for the drawing of a unit of blood.

The successful use of stem cells for treatment of numerous diseases is constantly being reported by the media. Most people are aware of the potential medical benefits of storing their own (autologous) stem cells, which will be a perfect match for the donor. The autologous use of the insured's stem cells would eliminate rejection and graft vs. host disease at time of transplant to alleviate or cure a medical problem for which stem cells might have application as science and technology advance to the point of allowing potential transplant of the stored stem cells.

It is the goal of this invention to assist in the education of everyone as to the significant medical benefits to stem cell perseveration.

This invention can benefit the insured and possibly the population at large, since the value of stem cell preservation is now being highly publicized.

1. A business method comprising:
establishing a Key Person, Term Life, or Critical Illness insurance policy program for selected policy holders or beneficiaries by an insurance company, collecting a premium to maintain said insurance policies for insured, and paying a service company a predetermined fee in support of services performed by said company on behalf of said policy holders regarding obtaining biological material from said insured and preserving said biological material during the term of said policies; and wherein said biological material may be used to extend the life of one or more of the insured during the term of the policy thereby reducing the likelihood of a payout to the policy holder or beneficiary by said insurance company.

2. The business method set forth in claim 1 wherein said services are continuing for the entire term of the insurance policies and said fee is a periodic fee paid at least in part at discrete intervals over said period of time.

3. The business method set forth in claim 1 wherein said policies are key-person, term life or critical illness insurance policies.

4. The business method according to claim 2 wherein said continuing services are for storage and preservation of biological materials ancillary to said health insurance policy, in addition to initialization services for collection, testing and processing biological material.

5. The business method set forth in claim 1 wherein said insurance policy is a key-person health insurance policy and said company stores biological materials ancillary to said insurance policy.

6. The business method set forth in claim 1 wherein said insurance policy is a term life insurance policy and said company stores biological materials ancillary to said life insurance policy.

7. The business method set forth in claim 1 wherein said insurance policy is a critical illness insurance policy and said company stores biological materials ancillary to said critical illness insurance policy.

8. The business method set forth in claim 8 wherein said biological materials are taken from the group consisting of adult stem cells, umbilical cord blood, placental blood, DNA, peripheral blood, bone marrow, adipose tissue and other adult tissue sources obtained from said insured.

9. The business method set forth in claim 11 wherein said policy holder is a corporation and said insured is an employee of said corporation.
